(19) United States
(12) Patent Application Publication
(10) Pub. No.: US 2014/0143896 A1
(43) Pub. Date: May 22, 2014

(54) Digital Certificate Based Theft Control for Computers

(71) Applicant: Xiaodong Richard Chen, Shanghai (CN)

(72) Inventor: Xiaodong Richard Chen, Shanghai (CN)

(21) Appl. No.: 14/078,942

(22) Filed: Nov. 13, 2013

Related U.S. Application Data
(63) Continuation of application No. 11/717,236, filed on Mar. 13, 2007, now abandoned.

(51) Int. Cl. G06F 21/57

(52) U.S. Cl. CPC G06F 21/575
USPC 726/35

(57) ABSTRACT

A theft control system may be implemented between a server and a client. The server may provide a certificate which must be periodically renewed. Execution of the certificate may be controlled by a trusted platform module on the client under control of a theft control controller.

### CROSS-REFERENCE TO RELATED APPLICATION

This application is a continuation application based on non-provisional application Ser. No. 11/717,236, filed Mar. 13, 2007, hereby expressly incorporated by reference herein.

### BACKGROUND

This relates to computer security.

Theft of valued digital assets, such as computers, has been a problem. More digitals assets are turning mobile and portable, making them even more attractive and prone to theft.

### BRIEF DESCRIPTION OF THE DRAWINGS

FIG. 1 is an architecture depiction of one embodiment of the present invention; and

FIG. 2 is a physical depiction of a theft control data model for one embodiment of the present invention.

### DETAILED DESCRIPTION

A digital certificate-based theft control system can render a theft controlled digital asset or computer useless by disabling boot once the computer is removed from the theft control system.

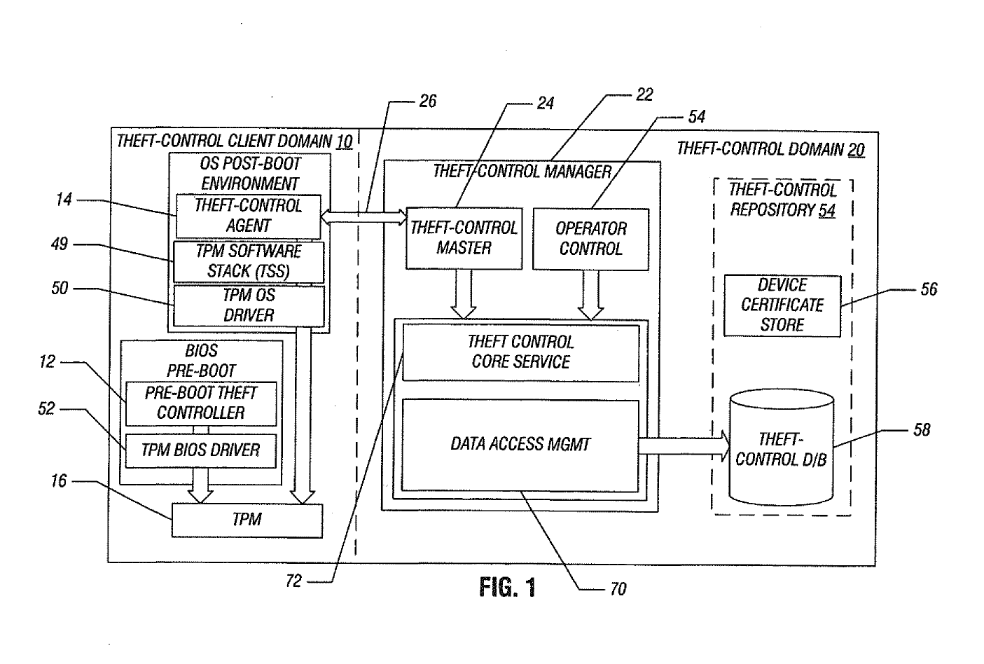

Referring to FIG. 1, the theft controlled computer may be divided into two domains. One domain is the client domain 10 for computers that have theft controlled client solution installed and enabled. The other domain is the server domain 20 that manages the theft control client account information and communicates with the clients for releasing clients with renewal boot certificates such that the client computers continue to boot. The pre-boot theft controller 12 may be part of a basic input/output system (BIOS) pre-boot environment. It is a part of the basic input/output system logic that gets loaded and executed during the system boot stage. It may check if a locally saved boot certificate has expired or not. If so, it halts the boot process and prompts for an unlock code to unlock the computer to allow further boots. If the boot certificate has not yet expired, it continues to boot until the operating system has loaded. In either case, the controller 12 first checks if there is any packet update inside the secured storage.

In one embodiment, the secured storage may be a trusted platform module 16 non-volatile random access memory for provisioning a packet-like boot certificate packet or stored secret packet which is downloaded from the theft control server 22. As used herein, a trusted platform module is a module that may be implemented pursuant to the Trusted Platform Module Specification 1.2, Revision 94, published on Mar. 29, 2006, available from the TPM Work Group under the auspices of the Trusted Computing Group. A trusted platform module may allow for secure generation of cryptographic keys and may include a hardware random number generator.

The trusted platform module 16 may be accessed by the agent 14 through a software stack 49 and a driver 50 or by the controller 12 through a driver 52.

When the computer is in a locked mode due to expiration of the boot certificate, the legitimate user can contact the theft control service administrator to obtain a valid unlock code for that computer. The legitimate user then enters the code into the computer manually and the pre-boot theft controller 12 verifies the authenticity and validity of the unlock code. If the unlock code passes, the computer is enabled to execute a pre-defined limited number of boots before the user must connect his or her computer with the theft control server 10 to download a new boot certificate inside the operating system environment after the successful unlock.

The theft control agent 14 is part of the operating system post-boot environment. It is a software process that automatically downloads a digital certificate from the theft control server module 22 when the process discovers that the host computer has a digital certificate that is going to expire and has fallen into a warning period. It also performs the mutual authentication with the server module 22 to prevent any network identity spoofing or man-in-the-middle attacks. Once the new digital certificate that is part of a total provisioning packet is downloaded, the packet may be directly stored into the trusted platform module 16 temporary data region. The software agent 14 may also be responsible for receiving other types of packets from the server domain 20, such as shared secret packet used for encryption, as well as verification of unlock code, and one-time boot certificate packet that is initiated from the theft control server side by an authorized person.

The theft control agent 14 may communicate through a driver 50 with the trusted platform module 16. Likewise, a basic input/output system driver 52 couples the pre-boot theft controller to the module 16.

The theft control master 24 is part of the theft control manager 22. The theft control master 24 is responsible for handling requests from clients. Once a secure connection 26, between the client and server has been established, the master 24 generates the provisioning packet for the client to download. Theft control manager 22 may include the operator control 54 for data access management through agent 14. The agent 14 receives data from the master 24. Both theft control master 24 and operator control 54 operate on theft control core service component 72 which operates on theft control data access management component 70. The theft control repository 54 may include a storage for certificates 56 and a theft control database 58.

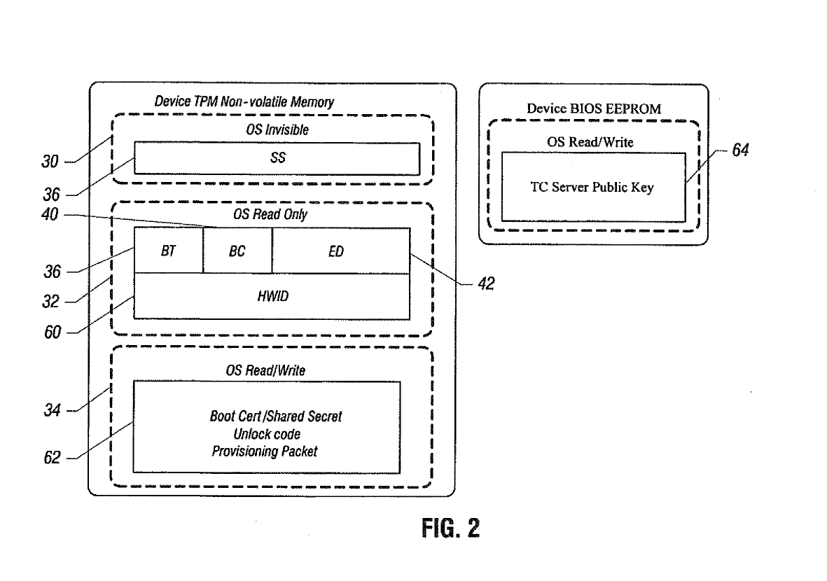

The trusted platform module chip 16 serves as a security engine with its secured storage. Inside the trusted platform module non-volatile random access memory there may be three different data regions that are configured as operating system invisible region 30, operating system read only region 32, and operating system readable and writable region 34, as shown in FIG. 2.

Three different data regions may be created for theft control data storage use. All three regions may be always read/write accessible to the basic input/output system during the basic input/output system boot stage. When the theft control agent 14 downloads the provisioning packet 62 from the server domain 20, it first stores the packet into the operating system read/write region 34. During the next reboot, the basic input/output system first verifies the packet to see that it comes from an authenticated source before parsing the packet and abstracting out internal values like shared secret 38, boot tick 36, boot counter 40, and expiry date 42. The packet is digitally signed and encrypted using public key infrastructure (PKI) methods such that unauthorized parties cannot decrypt or fake it.

The reason why the operating system should not be enabled to manipulate the value stored in the trusted platform module, like shared secret, is because the operating system is not supposed to be trusted because an operating system and software applications are likely to be compromised. In order to provide a high order of security protection, the trusted platform module 16 provides a secured storage and is also used in decrypting and verifying the provisioning packet.

The read only region 32 may include a MAC address 60. A public key 64 may be stored in a separate memory 66 that can be read or written to by the operating system.

In some embodiments, a trusted platform module is used as a secured storage and requires a trusted platform module custom function that does the verification during the basic input/output system boot stage. Thus, the operating system need not be trusted. Therefore, those who can access the operating system cannot defeat the theft control mechanism by software means since manipulation of data within the operating system domain does not compromise the system.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer system comprising:
a trusted platform module; and
a pre-boot environment theft controller to disable booting, said module storing a security certificate for a limited number of boots for said theft controller, said theft controller to disable booting if said security certificate has expired until an unlock code is provided by a user, enabling a limited number of additional boots.

2. The system of claim 1 including a storage device within said module.

3. The system of claim 2 wherein said storage device includes a first region which is invisible to an operating system.

4. The system of claim 3, said device including a second region that is only readable, but not writable, by the operating system.

5. The system of claim 4 including a third region in said device that is both operating system readable and writable.

6. The system of claim 1 wherein said trusted platform module to be used during the pre-boot environment to control the booting of said system.

7. A non-transitory computer readable medium storing instructions to enable a computer to:
use a pre-boot environment theft controller to control the booting of a computer system using a trusted platform module that stores a security certificate for a limited number of boots for said theft controller, said theft controller to disable booting if said security certificate has expired until an unlock code is provided by a user, enabling a limited number of additional boots.

8. The medium of claim 7 storing instructions to provide a storage device within said module.

9. The medium of claim 8 storing instructions to divide said storage device into three regions.

10. The medium of claim 9 storing instructions to provide a first region within said storage device which is invisible to an operating system.

11. The medium of claim 10 storing instructions to provide a second region within said device that is only readable and not writable by said operating system.

12. The medium of claim 11 storing instructions to provide a third region in said device that is both operating system readable and writable.

13. The medium of claim 7 storing instructions to enable said trusted platform module to control the booting of said system during a pre-boot environment.
